(19) United States
(12) Patent Application Publication
(10) Pub. No.: US 2012/0110361 A1
(43) Pub. Date: May 3, 2012

(54) Device For Controlling The Power Supply Of A Computer

(76) Inventors: Sylvain Durand, Annecy (FR); Nicolas Marchand, Montbonnet (FR)

(21) Appl. No.: 13/262,087

(22) PCT Filed: Mar. 29, 2010
(86) PCT No.: PCT/FR2010/000264

§ 371 Date: Dec. 19, 2011

(30) Foreign Application Priority Data
Mar. 31, 2009 (FR) 09/01576
Oct. 1, 2009 (FR) 09/04686

(51) Int. Cl. G06F 1/26

(52) U.S. Cl. 713/340

(57) ABSTRACT

The invention relates to a device for controlling a computer (4) capable of being powered with a plurality of voltage levels, including a controller (2) arranged so as to receive charge data (Ci), deadline data (Ni), and instantaneous speed data (w) for said computer (4), in order to calculate a reference speed that enables said computer to nm an amount of calculations drawn from the charge data (Ci) in a period drawn from the deadline data (Ni), and to calculate a control voltage level (V_lvl ) and operating frequency (f_op) for said computer from said reference speed. At least one element from among the reference speed and the operating frequency (f_op) is calculated using the instantaneous speed data (w).

The invention relates to a device for controlling the power supply of a computer.

The area of electronic circuits and the related components is a field that has experienced particularly rapid growth.

Initially, integrated circuits were large, and were made up of more or less substantial chips or processors grouped together on printed boards.

Advancements in miniaturization have made it possible to evolve toward chips the size of a microprocessor that contain various parts, or “IP.”

These integrated circuits are commonly called “System on Chip,” or SoC.

These integrated circuits are particularly interesting because they make it possible to contain a set of extremely varied functionalities in a very small size.

Furthermore, placing all of the elements of the circuit on a single chip reduces the system's consumption.

To reduce the consumption of the chips, work has been developed to adjust the operational voltage and frequency before the execution of a charge. However, this adaptation is not dynamic, i.e. the voltage and frequency do not vary during the processing of a given task. This is not adapted, in particular when the charge is poorly evaluated, or when it can vary.

The invention aims to improve the situation.

To that end, the invention proposes a control device for controlling a computer capable of being powered with a plurality of voltage levels, including a controller arranged so as to receive charge data, deadline data, and instantaneous speed data for said computer, in order to calculate a reference speed that enables said computer to run an amount of calculations drawn from the charge data in a period drawn from the deadline data, and to calculate a control voltage level and operating frequency for said computer from said reference speed.

In this device, at least one element from among the reference speed and the operating frequency is calculated using the instantaneous speed data.

The device is particularly advantageous because it makes it possible to emit power supply commands that are adapted to the logic needs emitted by the operating system using the computer, while maximally optimizing the energy consumption of the computer.

Other features and advantages of the invention will better appear upon reading the following description, taken from examples provided as an illustration and non-limitingly, taken from the drawings, in which:

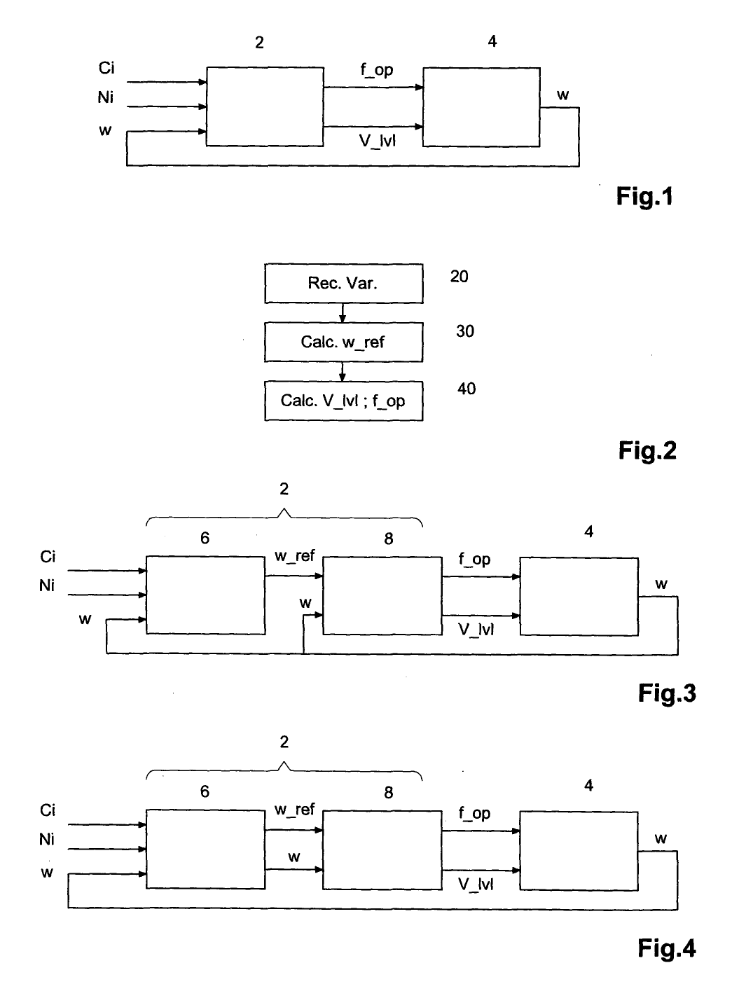

FIG. 1 shows a generic view of a device for controlling the power supply according to the invention,

FIG. 2 shows a schematic diagram of an operating loop of the device of FIG. 1,

FIG. 3 shows a first alternative embodiment of the device in FIG. 1,

FIG. 4 shows a second alternative embodiment of the device of FIG. 1,

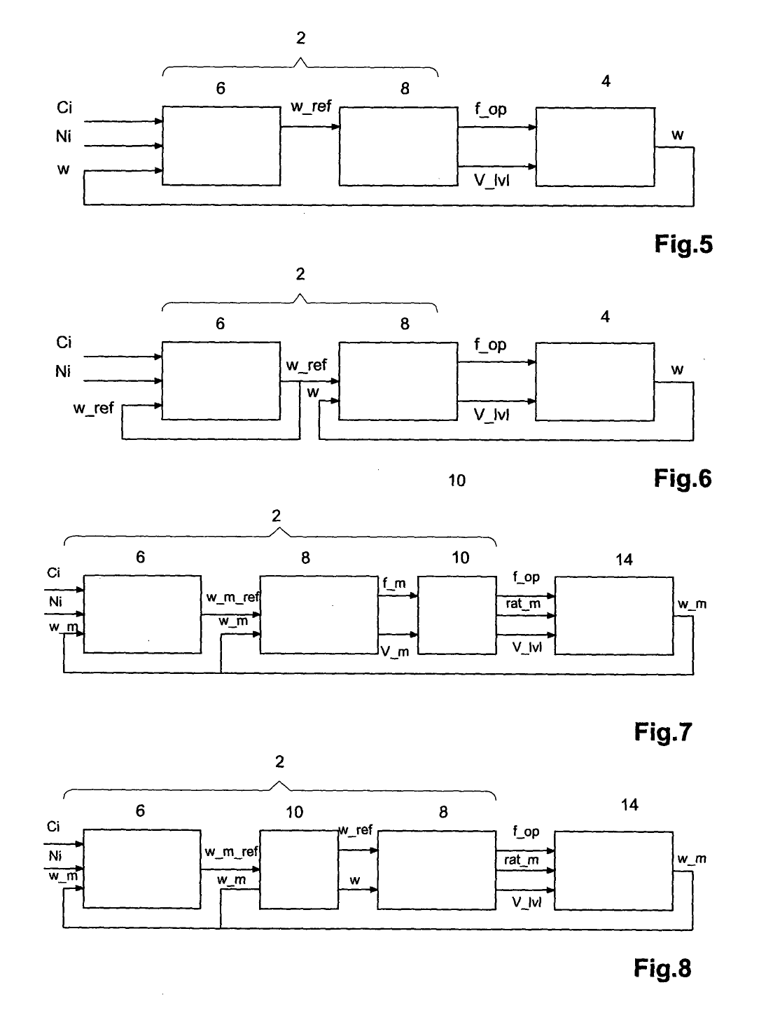

FIG. 5 shows a third alternative embodiment of the device of FIG. 1,

FIG. 6 shows a fourth alternative embodiment of the device of FIG. 1,

FIG. 7 shows another embodiment adapted to operate with a computer having several cores, and

FIG. 8 shows an alternative embodiment of the device of FIG. 7.

The drawings and description below essentially contain elements of a certain nature. They may therefore not only serve to make the present invention better understood, but also to contribute to its definition, if applicable.

Furthermore, the detailed description is expanded by Annex A, which provides the formulation for certain mathematical formulas used in the context of the invention. This Annex is presented separately for clarification purposes, and to facilitate references. It is an integral part of the description, and may therefore not only serve to make the present invention better understood, but also to contribute to its definition, if applicable.

The invention is particularly applicable in CMOS circuits. In these circuits, three primary sources of energy consumption exist:
switching the electric logic gates of the circuit,
short-circuit currents, and
leakage currents.

The instantaneous power of a given circuit can therefore be seen as the sum of these three powers, which is reflected by formula (10) in Annex A.

This formula shows the preponderant role of the supply voltage V of the circuit. One solution to reduce the consumption is therefore to lower the voltage.

However, this also results in greatly increasing the propagation delay of the logic gates of the circuit, which therefore lowers the speed at which the tasks are run by the circuit.

This means that as a function of the critical time, which is the maximum time that a given instruction can take to be processed by the circuit, it will be necessary to lower the frequency of the circuit, so as to ensure that all of the instructions are run before the following clock cycle.

In earlier works, there is no automated management of this type of adjustment to obtain energy savings.

FIG. 1 shows a device 2 for controlling a power supply according to the invention. The device 2 controls the power supply of a computer 4.

“Computer” refers to any electronic system that can perform logic operations for processing data or computations. For example, this non-limitingly includes processors, microprocessors, SoC chips, programmable chips of the FPGA type, and others.

As shown in FIG. 1, the device 2 for controlling the power supply receives data Ci and Ni on the one hand, and data w on the other hand.

The data Ci and Ni respectively represent charge data for the computer 4 and deadline data for the charge data.

The data Ci and Ni are received by the device 2 for controlling the power supply from a higher-level logic layer, for example from the operating system that uses the computer 4.

The data w received by the device 2 for controlling the power supply represent the operational processing speed of the computer 4.

This operational processing speed is used by the device 2 for controlling the power supply as retroaction information to avoid any drift relative to the instructions it gives out.

The voltage and frequency of the computer 4 can be controlled. In fact, the computer 4 can operate at different voltage levels, each voltage level having a corresponding range of possible operating frequencies.

This voltage level V_lvl and the operating frequency f_op are outputs of the device 2 for controlling the power supply.

The processing speed (from which the data w results) and the power consumed by the computer 4 result from the operating frequency f_op used as well as the power supply voltage V_lvl (or power supply level) of the computer 4, as seen with equation 10.

The computer 4 operates by clock cycles controlled by the operating frequency f_op. The device 2 for controlling the power supply operates similarly.

The device 2 for controlling the power supply operates by time period Ts, each period corresponding to the duration between two consecutive control computations. The period Ts is generally in the vicinity of several clock cycles of the computer 4.

In fact, it would be fairly inefficient to check the power supply of the computer 4 upon each clock cycle. Between two periods, the control device 2 emits the voltage level and operating frequency commands computed in the preceding period.

The period Ts of the device 2 for controlling the power supply can be a fixed parameter chosen as a function of the computer 4.

This period can also be adapted dynamically, i.e. it can be set at a multiple of the length of one cycle of the computer 4. In the example described here, the multiplier has a value of ‘10’ (ten). However, this value can be set at higher multiples.

Thus, upon each computation period, the device 2 for controlling the power supply analyzes the data Ci, Ni and w, and returns the data f_op and V_lvl as output to the computer 4.

It will be noted that, in the example described here, the device 2 for controlling the power supply sends power supply control data, and not the power supply itself.

The part of the circuit responsible for powering the computer 4 based on the control data coming from the device 2 for controlling the power supply is not addressed here.

FIG. 2 shows an operating loop of the device 2 for controlling the power supply. As seen above, the device 2 for controlling the power supply operates by computation periods.

The operating loop of the device 2 for controlling the power supply therefore starts with an operation 20 in which the data Ci, Ni and w that will be used is received.

Then, in an operation 30, the device 2 for controlling the power supply computes a reference speed w_ref.

The work done by the Applicant has revealed that, to minimize the energy consumption of the computer 4 for a given processing charge that must be done in a given period of time, the most crucial operating parameter of the computer 4 to be checked is the voltage level. This work has also revealed that it is dangerous to lower the voltage too much because there are risks of not finishing the computation charge by the deadline.

The device 2 for controlling the power supply will therefore implement a dynamic control of the power supply of the computer 4 so as to comply with the following instructions:
finish the computation charge before the deadline, and
maximally minimize the voltage used during that computation.

To that end, the device 2 for controlling the power supply starts upon each period by computing the “average” processing speed that the computer 4 should have in order to finish by the deadline designated by the data Ni the computer charge designated by the data Ci.

Then, the average speed is optimized from an energy consumption perspective to obtain a reference speed w_ref.

The average speed here is called delta. To calculate the delta speed, it is necessary to apply equation 20.

As shown by equation 20, the average speed is the amount of computation that remains to be processed, i.e. the charge taken from the data Ci minus the amount of computation that has already been processed, i.e. the sum of the instantaneous speeds w received multiplied by the time pitch of the device 2 for controlling the power supply, divided by the time Li remaining before the deadline, which is designated by the data Ni.

In fact, equation 20 amounts to writing that the average speed to have is the amount of data to be computed minus the amount already computed, the entire thing being divided by the remaining time.

Equations 30 and 32 show the application of equation 20 to the particular case of the operation by periods of the power supply device 2.

Once this average speed is computed, the device 2 for controlling the power supply will determine the reference speed w_ref.

The principle of the reference speed is to observe that it is advantageous to operate at a maximal frequency for a given voltage level, to be able to lower the voltage level as early as possible.

Thus, once the average speed delta is computed, the device 2 for controlling the power supply determines whether that speed corresponds to the frequency range of the voltage level established in the preceding period.

If it does, it determines whether that range corresponds to the lowest voltage level.

If that is the case, then w_ref receives delta. If not, then w_ref receives the maximum frequency of that range.

If the speed delta does not correspond to the frequency range of the voltage level established in the preceding period, the device 2 for controlling the power supply determines the voltage level that corresponds to the average speed delta.

This can for example be done through consecutive comparisons of the average speed delta with the maximum speed of each voltage level decreasing from the highest level.

In that case, the appropriate voltage level is the one for which the average speed delta is just below the maximum speed, and greater than the maximum speed of the following voltage level.

Of course, numerous other methods can be used to determine the voltage level to which the average speed delta corresponds.

Once this voltage level is determined, the device 2 for controlling the power supply proceeds identically to what was described above to compute the value of the reference speed w_ref.

Then, in an operation 40, the device 2 for controlling the power supply computes the operating frequency f_op that corresponds to the reference speed w_ref, and deduces therefrom the corresponding voltage level V_lvl.

The computation of the operating frequency f_op from the reference speed w_ref makes it possible to ensure that the computer 4 will operate the shortest time possible at a high voltage to run the computation charge designated by the data Ci.

In the embodiment of FIG. 1, the device 2 for controlling the power supply uses the data w to compute the operating frequency f_op, by using an order 1 system, according to equations 40 and 42.

Equation 40 shows the computation of the “error” between the reference speed w_ref and the instantaneous speed w received by the computer 4, and equation 42 shows how this error is used to compute the operating frequency f_op of the following time pitch.

It will be noted that Ts represents the period of the device 2 for controlling the power supply, and K is a gain.

FIG. 3 shows an alternative embodiment of the device 2 for controlling the power supply.

In this embodiment, the computation of the reference speed w_ref is separate from that of the operating frequency f_op and the voltage level V_lvl.

The device 2 for controlling the power supply thus includes a unit for computing the reference speed 6 and a control computation unit 8.

As appears in the drawings, the unit for computing the reference speed 6 receives the data Ci, Ni and w, and returns the reference speed w_ref.

For its part, the control computation unit 8 receives the reference speed w_ref and the data w, and returns the operating frequency data f_op and voltage level V_lvl as output.

In the example described here, the computer 4 is controlled on two voltage levels, respectively called Vlo (lowest) and Vhi (highest).

Here, the part of the operation 30 that determines the speed w_ref amounts to comparing the average speed delta to the maximum value of the frequency for the voltage level Vlo. If delta is greater than that value, then w_ref receives the maximum frequency value of the level Vhi, and otherwise w_ref receives delta.

Looping the data w both at the unit for computing the reference speed 6 and the control computation unit 8 makes it possible to be more effective when the number of clock cycles used by the unit for computing the reference speed 6 to determine the reference speed w_ref is very high.

The control computation unit 8 can therefore use the most recent data to establish the operating frequency f_op and the voltage level V_lvl, which ensures the best performance.

The power control device shown in FIG. 4 represents an alternative of the device of FIG. 3, in which the data w is only received by the reference speed computation unit 6, and is sent to the control computation unit 8.

This embodiment is potentially lower performing because the control computation unit 8 can operate with data w slightly less recent than the case of FIG. 3. However, this embodiment has the advantage of being easier to manufacture and use.

The power supply control device shown in FIG. 5 shows an even more simplified alternative of the control device of FIG. 3, in which the instantaneous speed data w is only transmitted to the reference speed computation unit 6, the control computation unit 8 here only receiving the reference speed data w_ref.

In that case, the operation 40 is greatly simplified, since the operating frequency f_op is set with the value w_ref, and the voltage level V_lvl directly deduced from that value.

This embodiment offers still slightly more reliable energy performance. However, it allows a remarkably simple manufacture and implementation.

The embodiment illustrated in FIG. 6 is an alternative in which only the control computation unit 8 receives the instantaneous speed data w.

In that case, the reference speed computation unit 6 only receives the reference speed data w_ref that it has previously computed.

To avoid any drift, the computation of the operating frequency f_op of the operation 40 implemented by the control computation unit 8 is made more robust, with the use of an order 2 system.

To that end, a first error is computed using formula 50, and that error is incorporated on the period of the reference speed computation unit 6 according to formula 52.

Then, the operating frequency f_op is determined using formula 54, in which T represents the time constant of the system once looped, and K is the gain.

FIG. 7 shows a device 2 adapted to control a computer 14 that comprises several cores. This means that, within the computer 14, it contains, in the described example, four computation units similar to the computer 4 that can be addressed independently.

The computer 14 may in other embodiments comprise as many cores as necessary, i.e. at least two and more than four, for example 32 or more.

In this context, an even sharper power supply problem arises. In fact, it is not reasonable to power each core of the computer 14 each with a voltage level/frequency pair specific to it.

It is therefore not possible to consider simply replicating the basic architecture as many times as there are cores in the computer 14.

A first approach to resolve this problem is to look for a voltage level and frequency that constitutes a “consensus.” However, this is not acceptable, because a critical task then cannot be run in time.

A second approach is then to make all of the cores operate at the voltage and frequency of the most critical task. However, this tends to destroy the energy gains.

The Applicant has found a compromise between these two solutions.

To that end, a limiter 10 is introduced into the device 2. The function of the limiter 10 is to compute, for each core, the ratio between the frequency of the most critical tasks of all of the tasks and the frequency that that core must use to carry out its task in the single-core case.

At each computer 14, the ratios determined by the limiter 10 are used so that each core performs its task at a speed that substantially corresponds to that which it would have used in the single-core case.

To that end, the computer 14 can incorporate a material solution via specific electronics that suspend the clock from the nodes 4 of the computer 14.

Thus, each core operates as in a single-core mode, but at a voltage level that can be higher (this depends on the critical task).

These electronics (called “clock-gating”) allow the transmission or non-transmission of the clock fronts to the different nodes 4 of the computer 14 and can for example be done using an AND logic gate.

Alternatively, the electronics can be replaced by a software solution. Thus, rather than modulating the frequency of each core, they will be selectively “put to sleep,” so that over a significant quantity of cycles, each core performs its task at a speed that corresponds substantially to that which it would have used in the single-core case.

This is done by adding instructions to the stream-line called “No Op,” i.e. requests that ask the concerned core not to do anything.

This alternative has the advantage of being more upgradeable, because of the software. This means that updating the microprogram would make it possible to upgrade it.

However, it is less advantageous because it limits the frequency modulation to a fraction of the operating frequency: half (one No Op for each operation), one third (two No Ops for each operation), one quarter (three No Ops for each operation), etc.

It remains possible to sophisticate the latter solution to obtain any rational number, but then the gains in terms of architecture simplification are reduced.

In the embodiment described in FIG. 7, the reference speed computation 6 and the control computation unit 8 are replicated as many times as there are cores. As a result, the instantaneous speed data is a byte w_m and the reference speed data w_m_ref is also a byte.

As output, the control computation unit 8 emits a byte of frequencies f_m and a byte of voltage levels V_m.

The limiter 10 is arranged at the output of the control computation unit 8. It therefore receives the frequency byte f_m and the voltage levels byte V_m.

First, the limiter 10 will compare all of the frequencies of the byte f_m and selects the highest. This frequency will be sent as an instruction f_op to the computer 14 and the corresponding core is called the critical core.

Then, the limiter 10 selects the voltage level of the byte V_m, which corresponds to the critical core previously designated. This voltage level will be sent as instruction V_lvl to the computer 14.

Lastly, the limiter 10 computes a byte rat_m that contains the ratio between each of the frequencies of the byte f_m and the frequency f_op.

In the case where the software solution is chosen to lower the frequency of the cores, the ratio that ensure completion of the task should be applied, even if it is energetically less favorable.

Thus, if one finds a ratio greater than two but less than three, it will be necessary to choose a ratio of 1/2.

Moreover, it is important for the frequencies of the different blocks to be well-synchronized. In fact, as the frequency decrease of the cores is obtained by adding fictitious instructions, the instructions must not be updated too often or too slowly.

The Applicant has identified that an order of magnitude in the vicinity of 1000 is advantageous in the context of the invention.

Thus, the system that controls the tasks sent to the computer will work with a frequency in the vicinity of 1 kHz, the control device of the invention will work with a frequency in the vicinity of 1 MHz, and the computer strictly speaking will work with a frequency in the vicinity of 1 GHz.

However, other orders of magnitude can be used as a function of the deadlines granted to process the tasks, for example 10, 100, or more than 1000.

In light of the preceding, it will be understood that the invention relates to the implementation of a power supply control for an electronic system that performs the computations.

In the described examples, this control is made dynamic and adaptive owing to the use of systems of orders 1 and 2. “System of orders 1 and 2” refers to a system whereof the function that performs the computation of the control comprises a polynomial whereof the highest-degree monomial is 1 or 2. Higher-order systems could also be used.

Furthermore, the device 2 for controlling the power supply has been described here as an element external to the computers 4 and 14, and separate therefrom. This means that the computations used to compute the power supply control are not done within the computer.

However, in certain applications, the device 2 for controlling the power supply could be incorporated into the computer, and the implementation of the computations for controlling the power supply could then be done by the computer 4 or 14, the control taking this computation overcharge into account.

Furthermore, the Applicant has described a device for controlling a power supply in which the computer can be powered on several levels. One particular example has been described for a power supply with two voltage levels.

In these examples, to determine a suitable voltage level for the average speed delta, a rise/descent loop of the voltage level is described to determine the suitable frequency range.

Other methods could be used, such as storing a table of frequency ranges per voltage level, and access to that table to take the adapted voltage level from it.

Lastly, the Applicant has described a device in which the operating frequency is computed continuously. It would nevertheless be possible to apply the preceding to operate at a discrete frequency.

It is then a matter of determining a frequency level instead of a continuous frequency value, similarly to what has been described to compute the voltage level. In this case, the controller 2 can be simplified to then only contain a single computation block of the frequency and voltage levels, i.e. the units 6 and 8 can be merged.

$$\begin{matrix}\underline{ANNEX A} & \\ P = {P}_{Portes} + {P}_{cc} + {P}_{fruits} = {K}_{portes} \cdot {f}_{clk} \cdot {V}^{2} + {K}_{cc} \cdot {f}_{clk} \cdot V + {K}_{fruits} \cdot V & ( 10 ) \\ δ ( t ) = \frac{{c}_{i} ( t ) - \int w ( t ) d t}{{L}_{i} ( t )} & ( 20 ) \\ Ω ( {t}_{k} ) = Ω ( {t}_{k - 1} ) + {T}_{s} \cdot w ( {t}_{k} ) & ( 30 ) \\ δ ( {t}_{k + 1} ) = \frac{{c}_{i} ( {t}_{k} ) - {Ω}_{k}}{{L}_{i} ( {t}_{k} )} & ( 32 ) \\ ɛ ( k ) = {w}_{ref ( k )} - w ( k ) & ( 40 ) \\ {f}_{op} ( k ) = {f}_{op} ( k - 1 ) + {T}_{s} \cdot K \cdot ɛ ( k ) & ( 42 ) \\ ɛ ( k ) = {w}_{ref ( k )} - w ( k ) & ( 50 ) \\ E ( k ) = E ( k - 1 ) + {T}_{s} \cdot ɛ ( k ) & ( 52 ) \\ {f}_{op} ( k ) = {f}_{op} ( k - 1 ) + \frac{{T}_{s} - τ}{K} \cdot E ( k - 1 ) + \frac{τ}{K} \cdot E ( k ) & ( 54 )\end{matrix}$$

1. A control device for controlling a computer capable of being powered with a plurality of voltage levels, including a controller arranged so as to receive charge data, deadline data, and instantaneous speed data for said computer, in order to calculate a reference speed that enables said computer to run an amount of calculations drawn from the charge data in a period drawn from the deadline data, and to calculate a control voltage level and operating frequency for said computer from said reference speed, at least one element among the reference speed and the operating frequency being computed from instantaneous speed data.

2. The device according claim 1, wherein the controller comprises a unit for computing the reference speed to compute the reference speed and a control computation unit to compute the operating frequency and the voltage level.

3. The device according to claim 2, also comprising a limiter, the computer comprising several cores, wherein the limiter determines the reference speed for the one of the cores having the most critical task, as well as a byte of frequency ratios to run tasks of the other cores of the computer.

4. The device according to claim 3, wherein the limiter is arranged between the reference speed computation unit and the control computation unit.

5. The device according to claim 3, wherein the limiter is arranged downstream of the control computation unit.

6. The device according to one of claim 2, wherein the control computation unit computes the operating frequency from instantaneous speed data with an order 1 system.

7. The device according to claim 6, wherein the reference speed computation unit computes the reference speed from instantaneous speed data.

8. The device according to claim 7, wherein the instantaneous speed data is sent to the control computation unit by the reference speed computation unit.

9. The device according to claim 2, wherein the control computation unit computes the operational frequency from instantaneous speed data with an order 2 system.

10. The device according to claim 3, wherein the control computation unit computes the operational frequency from instantaneous speed data with an order 2 system.

11. The device according to claim 4, wherein the control computation unit computes the operational frequency from instantaneous speed data with an order 2 system.

12. The device according to claim 5, wherein the control computation unit computes the operational frequency from instantaneous speed data with an order 2 system.

13. The device according to claim 3, wherein the control computation unit computes the operating frequency from instantaneous speed data with an order 1 system.

14. The device according to claim 13, wherein the reference speed computation unit computes the reference speed from instantaneous speed data.

15. The device according to claim 14, wherein the instantaneous speed data is sent to the control computation unit by the reference speed computation unit.

16. The device according to claim 4, wherein the control computation unit computes the operating frequency from instantaneous speed data with an order 1 system.

17. The device according to claim 16, wherein the reference speed computation unit computes the reference speed from instantaneous speed data.

18. The device according to claim 17, wherein the instantaneous speed data is sent to the control computation unit by the reference speed computation unit.

19. The device according to claim 5, wherein the control computation unit computes the operating frequency from instantaneous speed data with an order 1 system.

20. The device according to claim 19, wherein the reference speed computation unit computes the reference speed from instantaneous speed data.
